(19) United States
(12) Patent Application Publication
(10) Pub. No.: US 2024/0335848 A1
(43) Pub. Date: Oct. 10, 2024

(54) SPRAY GUN HEAD AND SPRAYER USING SAME

(71) Applicant: NINGBO JINYU TECHNOLOGY INDUSTRY CO., LTD., Ningbo (CN)

(72) Inventors: Cheng HANG, Ningbo (CN); Gongshun DUAN, Ningbo (CN)

(21) Appl. No.: 18/242,533

(22) Filed: Sep. 6, 2023

Related U.S. Application Data
(63) Continuation of application No. PCT/CN2023/086489, filed on Apr. 6, 2023.

(51) Int. Cl. B05B 11/00; B05B 11/10

(52) U.S. Cl. CPC B05B 11/0008; B05B 11/0089; B05B 11/1057

(57) ABSTRACT

The present invention relates to a spray gun head and a sprayer using the same. The spray gun head includes a connecting cap, a gun body, and a blank cap, where the connecting cap has an internal thread; the gun body is located above the connecting cap; and the blank cap is arranged on the connecting cap, and a lower end of the gun body is rotatably arranged on the blank cap along a circumferential direction of the blank cap, such that even if the gun body rotates under a force, the gun body can only rotate along the circumferential direction of the blank cap, without driving the connecting cap to rotate relative to a liquid container, thus avoiding the outflow of a liquid in the liquid container due to the rotation of the gun body.

### CROSS-REFERENCE TO RELATED APPLICATIONS

The present application is a continuation of International Application No. PCT/CN2023/086489, with an international filing date of Apr. 6, 2023, which is based upon and claims priority to Chinese Patent Application No. 202310140740.4, filed on Feb. 21, 2023, the entire contents of all of which are incorporated herein by reference.

### FIELD OF TECHNOLOGY

The present invention relates to the field of sprayers, in particular to a spray gun head and a sprayer using the same.

### BACKGROUND

An existing sprayer mainly includes a spray gun head (or called as a spray gun) and a liquid container, where the spray gun head is provided with a liquid transport tube of which one end extends into the liquid container; the spray gun head (or called as the spray gun) mainly includes a connecting cap and a gun body; a lower end of the connecting cap is fastened to an upper end of the liquid container in a threaded connection manner; and the gun body is fastened to an upper end of the connecting cap. In the process of transporting the sprayer containing a liquid, the spray gun head, especially the gun body, is influenced by various acting forces, such that the gun body may rotate to drive the connecting cap to rotate. As a result, it is very likely to reduce the effect of fastening between the connecting cap and the liquid container, and eventually the liquid in the liquid container flows out from an opening in an upper end of the liquid container to cause waste. Therefore, it is difficult to meet the transportation requirements of the sprayer containing the liquid.

### SUMMARY

To solve the first technical problem in the prior art above, the present invention provides a spray gun head capable of avoiding the outflow of a liquid in a liquid container due to rotation of a gun body.

To solve the second technical problem, the present invention provides a sprayer using the above spray gun head.

To solve the first technical problem, the present invention adopts the following technical solution: a spray gun head, including:
a connecting cap, having an internal thread;
a gun body, located above the connecting cap; and
a blank cap, arranged on the connecting cap, where a lower end of the gun body is rotatably arranged on the blank cap along a circumferential direction of the blank cap.

As an improvement, in the spray gun head, a slide rail groove is formed in the blank cap, and the lower end of the gun body is slidably arranged on the slide rail groove.

Further, in the spray gun head, a slide fit structure is formed at the lower end of the gun body and slidably arranged in the slide rail groove.

Furthermore, in the spray gun head, the slide rail groove is an annular groove formed along the circumferential direction of the blank cap.

As a further improvement, in the spray gun head, the blank cap is arranged on an inner side of the connecting cap.

As an improvement, in the spray gun head, the blank cap has an opening penetrated by at least a liquid transport tube of the gun body in a matched manner.

Further, in the invention, the spray gun head further includes a marble seat, where a through hole being through in an up-down manner is formed in the marble seat, a marble is arranged at an upper end of the through hole, an upper end part of the marble seat penetrates through the opening of the blank cap and is arranged in the gun body, and the liquid transport tube has one end located in the through hole and the other end penetrating through the connecting cap and capable of extending into a liquid container.

As a further improvement, in the invention, the spray gun head further includes a sealing ring, where the sealing ring has an open hole penetrated by a lower end of the marble seat in a matched manner and is located on the inner side of the connecting cap and arranged below the blank cap.

As a further improvement, in the invention, the spray gun head further includes a spray gun component with a water distribution rod, and a continuous press type structure for automatically sealing the water distribution rod during liquid feeding.

Further, in the spray gun head, the continuous press type structure includes:
a wrench, arranged on the gun body in a manner of moving back and forth;
a piston, linked with the wrench and arranged in a water inlet cavity of the gun body in a manner of moving back and forth, where the water inlet cavity communicates with a water outlet cavity where the spray gun component is located;
a first elastic component, linked with the piston and telescopically arranged in the water inlet cavity of the gun body; and
a second elastic component, connected to the wrench and telescopically located on an outer side of the water inlet cavity of the gun body;
where the piston squeezes the first elastic component under a pressure of the wrench to be compressed to allow water to enter the water inlet cavity, and then the marble moves to seal the through hole.

To solve the second technical problem, the present invention adopts the following technical solution: a sprayer, including a liquid container, where any one of the spray gun heads described is further used.

Compared with the prior art, the present invention has the advantages that in the spray gun head according to the present invention, the blank cap with the slide rail groove is additionally arranged on the connecting cap, and the lower end of the gun body is rotatably arranged in the slide rail groove of the blank cap along the circumferential direction of the blank cap, such that even if the gun body rotates under a force, the gun body can only rotate along the slide rail groove, without driving the connecting cap to rotate relative to the liquid container, thus avoiding the outflow of a liquid in the liquid container due to the rotation of the gun body. In addition, by arranging the continuous press type structure for automatically sealing the water distribution rod during the liquid feeding, good technical effects of preventing air backflow, instantaneously sealing to cut off the liquid, having better single sealing property and stronger explosive force, and avoiding liquid dripping can be achieved.

### BRIEF DESCRIPTION OF THE DRAWINGS

FIG. 1 is a schematic structural diagram of a spray gun head in an embodiment of the present invention;

FIG. 2 is another schematic diagram of a spray gun head shown in FIG. 1;

FIG. 3 is a sectional view of a spray gun head shown in FIG. 1;

FIG. 4 is a schematic enlarged view of A in FIG. 3; and

FIG. 5 is a schematic diagram of an exploded structure of a spray gun head shown in FIG. 1.

### DESCRIPTION OF THE EMBODIMENTS

The present invention is further described in detail below in conjunction with the accompanying drawings and the embodiments.

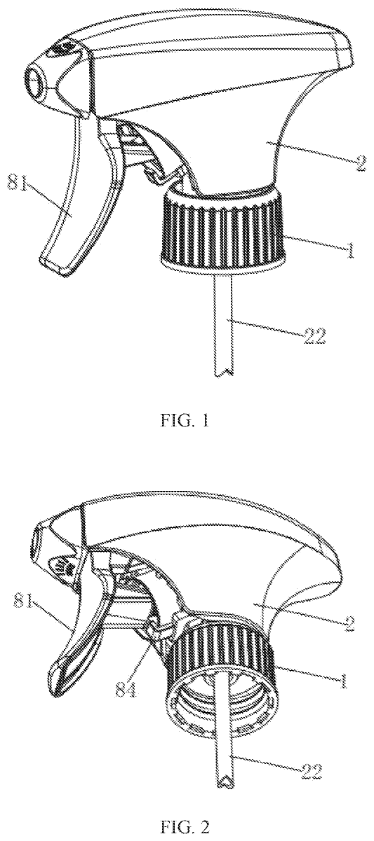

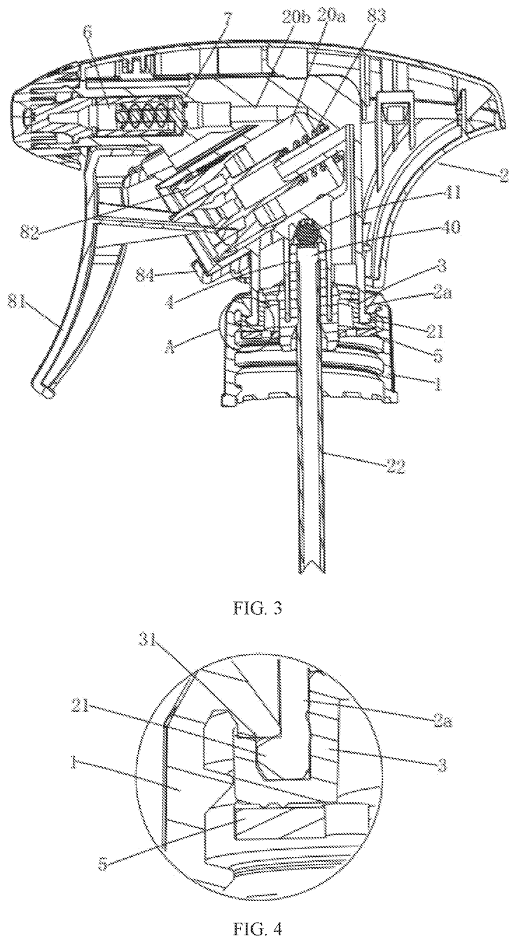

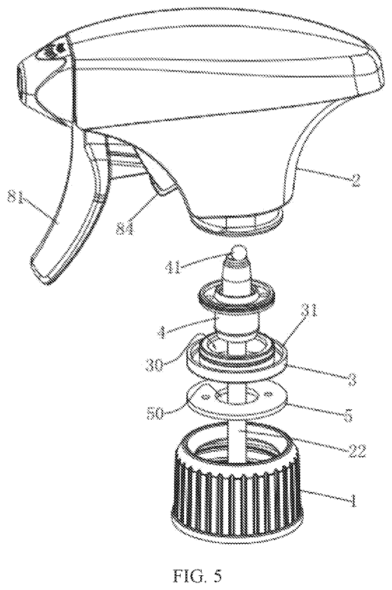

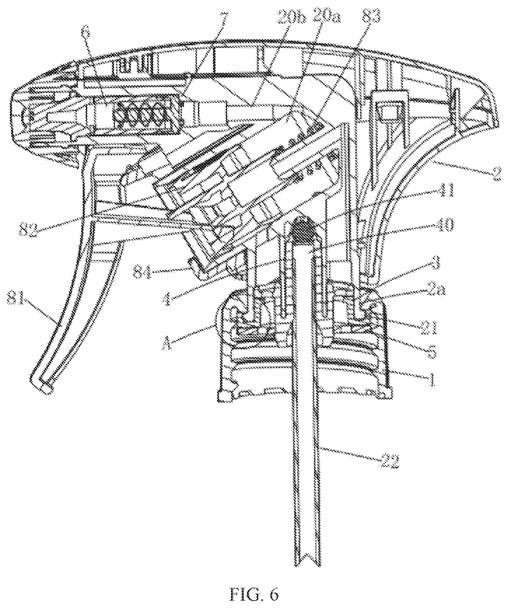

An embodiment provides a spray gun head capable of avoiding the outflow of a liquid in a liquid container due to rotation of a gun body. Specifically, as shown in FIGS. 1-5, the spray gun head in this embodiment includes a connecting cap 1, a gun body 2, a blank cap 3, a marble seat 4, and a sealing ring 5, where the connecting cap 1 has an internal thread; the gun body 2 is located above the connecting cap 1; the blank cap 3 is arranged on an inner side of the connecting cap 1, has an opening 30 penetrated by at least a liquid transport tube 22 of the gun body 2 in a matched manner, and is provided with a slide rail groove 31 that is an annular groove formed along a circumferential direction of the blank cap 3; and a slide fit structure 21 is formed at a lower end 2a of the gun body 2 and slidably arranged in the slide rail groove 31. As a result, the gun body 2 can be rotatably arranged on the blank cap 3 along the circumferential direction of the blank cap 3. A through hole 40 being through in an up-down manner is formed in the marble seat 4, a marble 41 is arranged at an upper end of the through hole 40, an upper end part of the marble seat 4 penetrates through the opening 30 of the blank cap 3 and is arranged in the gun body 2, and the liquid transport tube 22 has one end located in the through hole 40 and the other end penetrating through the connecting cap 1 and capable of extending into a liquid container; and the sealing ring 5 has an open hole 50 penetrated by a lower end of the marble seat 4 in a matched manner and is located on the inner side of the connecting cap 1 and arranged below the blank cap 3.

To prevent air backflow during operation of the spray gun head and avoid liquid dripping of the spray gun head, the spray gun head in this embodiment further includes a spray gun component 7 with a water distribution rod 6, and a continuous press type structure for automatically sealing the water distribution rod 6 during liquid feeding. The continuous press type structure includes a wrench 81, a piston 82, a first elastic component 83, and a second elastic component 84, where the wrench 81 is arranged on the gun body 2 in a manner of moving back and forth; the piston 82 is linked with the wrench 81 and is arranged in a water inlet cavity 20a of the gun body 2 in a manner of moving back and forth; the water inlet cavity 20a communicates with a water outlet cavity 20b where the spray gun component 7 is located; the first elastic component 83 is linked with the piston 82 and telescopically arranged in the water inlet cavity 20a of the gun body 2; the second elastic component 84 is connected to the wrench 81 and telescopically located on an outer side of the water inlet cavity 20a of the gun body 2; and the piston 82 squeezes the first elastic component 83 under a pressure of the wrench 81 to be compressed to allow water to enter the water inlet cavity 20a, and then the marble 41 moves to seal the through hole 40. In this way, it can be ensured that the water does not flow back from the through hole 40 of the marble seat 4 any more after the water enters the water inlet cavity, and thus the pressure of the water sprayed by the spray gun component is increased. As a result, the effects of preventing air backflow, instantaneously sealing to cut off the liquid, having better single sealing property and stronger explosive force, and avoiding liquid dripping are achieved. According to actual needs, the first elastic component 83 herein is a spring, for example, may be a metal spring or a non-metal spring (such as a spring made of a plastic material). The second elastic component 84 may be a plastic spring or a plastic elastomer.

In addition, an embodiment provides a sprayer using the above spray gun head. The sprayer includes a liquid container, and an upper end of the liquid container is fastened and connected to a lower end of a connecting cap 1 of the sprayer in a threaded manner.

After the spray gun head in this embodiment is applied to the sprayer, if a gun body 2 rotates under an external force during transportation, the gun body 2 only rotates 360° circumferentially along a slide rail groove 31 on a blank cap 3, and the gun body 2 will never drive the connecting cap 1 to rotate. As a result, the connecting cap 1 will not rotate relative to the liquid container, thus avoiding the outflow of a liquid in the liquid container due to the rotation of the gun body.

Although the preferred embodiments of the present invention have been described in detail above, it should be clearly understood that the present invention may be subjected to various modifications and variations for those skilled in the art. Any modifications, equivalent substitutions, improvements, etc. made within the spirit and principle of the present invention should be included within the scope of protection of the present invention.

What is claimed is:

1. A spray gun head, comprising:
a connecting cap, having an internal thread;
a gun body, located above the connecting cap; and
a blank cap, arranged on the connecting cap, wherein a lower end of the gun body is rotatably arranged on the blank cap along a circumferential direction of the blank cap.

2. The spray gun head of claim 1, wherein a slide rail groove is formed in the blank cap, and the lower end of the gun body is slidably arranged on the slide rail groove.

3. The spray gun head of claim 2, wherein a slide fit structure is formed at the lower end of the gun body and slidably arranged in the slide rail groove.

4. The spray gun head of claim 3, wherein the slide rail groove is an annular groove formed along the circumferential direction of the blank cap.

5. The spray gun head of claim 1, wherein the blank cap is arranged on an inner side of the connecting cap; or/and the blank cap has an opening penetrated by at least a liquid transport tube of the gun body in a matched manner.

6. The spray gun head of claim 5, further comprising a marble seat, wherein a through hole being through in an up-down manner is formed in the marble seat, a marble is arranged at an upper end of the through hole, an upper end part of the marble seat penetrates through the opening of the blank cap and is arranged in the gun body, and the liquid transport tube has one end located in the through hole and the other end penetrating through the connecting cap and capable of extending into a liquid container.

7. The spray gun head of claim 6, further comprising a sealing ring, wherein the sealing ring has an open hole penetrated by a lower end of the marble seat in a matched manner and is located on the inner side of the connecting cap and arranged below the blank cap.

8. The spray gun head of claim 6, further comprising a spray gun component with a water distribution rod, and a continuous press type structure for automatically sealing the water distribution rod during liquid feeding.

9. The spray gun head of claim 8, wherein the continuous press type structure comprises:
a wrench, arranged on the gun body in a manner of moving back and forth;
a piston, linked with the wrench and arranged in a water inlet cavity of the gun body in a manner of moving back and forth, wherein the water inlet cavity communicates with a water outlet cavity where the spray gun component is located;
a first elastic component, linked with the piston and telescopically arranged in the water inlet cavity of the gun body; and
a second elastic component, connected to the wrench and telescopically located on an outer side of the water inlet cavity of the gun body;
wherein the piston squeezes the first elastic component under a pressure of the wrench to be compressed to allow water to enter the water inlet cavity, and then the marble moves to seal the through hole.

10. A sprayer, comprising a liquid container, wherein the spray gun head of claim 1 is further used.
